(19) United States
(12) Patent Application Publication
(10) Pub. No.: US 2011/0067311 A1
(43) Pub. Date: Mar. 24, 2011

(54) Window Regulator Lifter Plate With Integrated Lubrication System

(76) Inventor: Thomas Peter Corden, Birmingham, MI (US)

(21) Appl. No.: 12/885,860

(22) Filed: Sep. 20, 2010

Related U.S. Application Data
(60) Provisional application No. 61/276,988, filed on Sep. 18, 2009.

(51) Int. Cl. E06B 7/00; E05F 11/38; F16N 7/00

(52) U.S. Cl. 49/70; 184/14

(57) ABSTRACT

A window regulator assembly for moving a window pane between an open position and a closed position includes a rail and a lifter plate slidably coupled with the rail. The lifter plate is coupled with the window pane and is guided by the rail to move the window pane between the open and closed positions. A lubrication system lubricates the rail as the lifter plate moves the window pane between the open and closed positions. The lubrication system includes a reservoir contained within the lifter plate, a lubricant storing and releasing material disposed in the reservoir, and an applicator extending from within the reservoir to lubricate the rail.

### BACKGROUND OF THE INVENTION

1. Field of the Invention

The present invention relates to a window regulator assembly and, more particularly, to a lifter plate that includes an integrated lubrication system.

2. Description of Related Art

Automotive vehicles commonly include vehicle doors having a plastic carrier panel that is sandwiched between an exterior door panel and an interior door panel. The carrier panel is provided to support various components that are housed within the vehicle door such as a radio speaker and a window regulator assembly. The window regulator assembly includes a rail that is typically molded as part of the carrier panel and a lifter plate that is slidably coupled to the rail. The lifter plate supports a window pane and the rail guides the lifter plate in a vertical direction for movement of the window pane between a lowered or open position and a raised or closed position. The lifter plate is moved up and down along the rail by a cable or cables that are guided by pulleys disposed at opposite ends of the rail. The cable is driven by a reversible motor.

Typically, grease is used to lubricate the interface between the lifter plate and rail to ensure smooth and easy operation of the window pane between the open and closed positions. The grease is applied to the rail during assembly of the vehicle door, but as the lifter plate moves along the rail, it acts as a plow, and moves the grease aside. Repeated cycling of the window pane between the open and closed positions continues to remove the grease. Over time, with less grease on the rail, the movement of the window pane may become jerky or result in an audible scraping noise from within the vehicle door as the lifter plate moves along the rail. Less grease on the rail also results in a greater force being required to move the window pane, which puts a strain on the motor, cables and pulleys leading to early failure.

It is therefore desirable to provide a lifter plate having an integrated lubrication system to continuously lubricate a rail as the lifter plate travels up and down along the rail to move a window pane between an open position and a closed position.

### SUMMARY OF THE INVENTION

According to one embodiment of the invention, a window regulator assembly for moving a window pane between an open position and a closed position includes at least one elongated rail and a lifter plate slidably coupled with the at least one elongated rail. The lifter plate is adapted to be coupled with the window pane. The at least one elongated rail guides the lifter plate to move the window pane between the open and closed positions. A lubrication system lubricates the at least one elongated rail as the lifter plate moves the window pane between the open and closed positions. The lubrication system includes a reservoir contained within the lifter plate, a lubricant storing and releasing material disposed in the reservoir, and an applicator extending from within the reservoir to lubricate the at least one elongated rail.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is an upper perspective view of a plastic carrier panel for a vehicle door;

FIG. 2 is a front perspective view of a lifter plate for a window regulator assembly according to one embodiment of the invention;

FIG. 3 is a front view of the lifter plate;

FIG. 4 is an enlarged view of detail 4 in FIG. 3;

FIG. 5 is a fragmentary, cross-sectional view of the lifter plate and plastic carrier panel illustrating a lubrication system; and

FIG. 6 is a rear perspective view of the lifter plate.

### DETAILED DESCRIPTION OF THE EMBODIMENTS

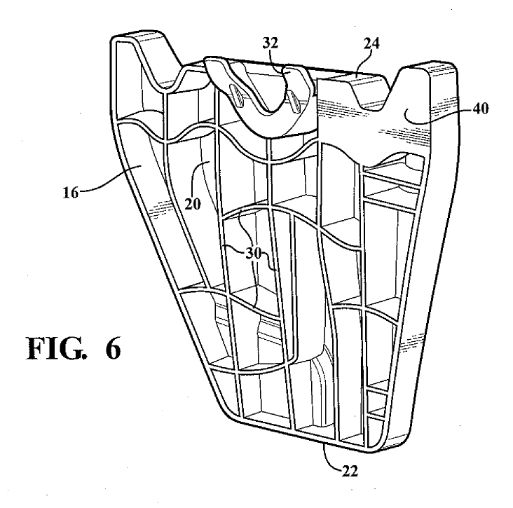

Referring to the Figures, a plastic carrier panel 10 for a vehicle door is shown. The carrier panel 10 includes a window regulator assembly 12 that is used for moving a window pane (not shown) between a lowered or open position and a raised or closed position, as is well known in the art. The window regulator assembly 12 includes at least one elongated rail 14 and at least one lifter plate 16 slidably coupled to the rail 14. In the embodiment shown, the rail 14 is integrally molded with the carrier panel 10 and extends in a generally vertical direction. The rail 14 has a generally L-shaped cross-section, as shown in FIG. 5. The lifter plate 16 is adapted to support the window pane and the rail 14 guides the lifter plate 16 for sliding movement along the rail 14 in the vertical direction for movement of the window pane between the open and closed positions. It is contemplated that the lifter plate 16 is moved along the rail 14 in the vertical direction by a reversible motor (not shown) that drives a cable or cables (not shown), which are guided by pulleys (not shown) disposed at opposite ends of the rail 14. It is appreciated, however, that the lifter plate 16 may be moved along the rail 14 by any suitable means without varying from the scope of the invention.

The lifter plate 16 is configured to include a front side 18, a rear side 20, a lower end 22 and an upper end 24. The front side 18 of the lifter plate 16 includes a cable attachment portion 26 for coupling the lifter plate 16 to the cable or cables. The front side 18 also includes a pair of clips 28 that are spaced apart in the vertical direction. The clips 28 are suitably formed to engage the L-shaped cross-section of the rail 14, thereby slidably coupling the lifter plate 16 to the rail 14. When the lifter plate 16 is assembled with the carrier panel 10 the front side 18 of the lifter plate 16 is disposed directly adjacent to the carrier panel 10. The rear side 20 of the lifter plate 16 includes a plurality of stiffening ribs 30 that provide structural rigidity to the lifter plate 16. The rear side 20 also includes a mount 32 for receiving a lower edge of the window pane. A screw, bolt or other attachment means extends through an aperture 34 in the lifter plate 16 to secure the window pane to the lifter plate 16.

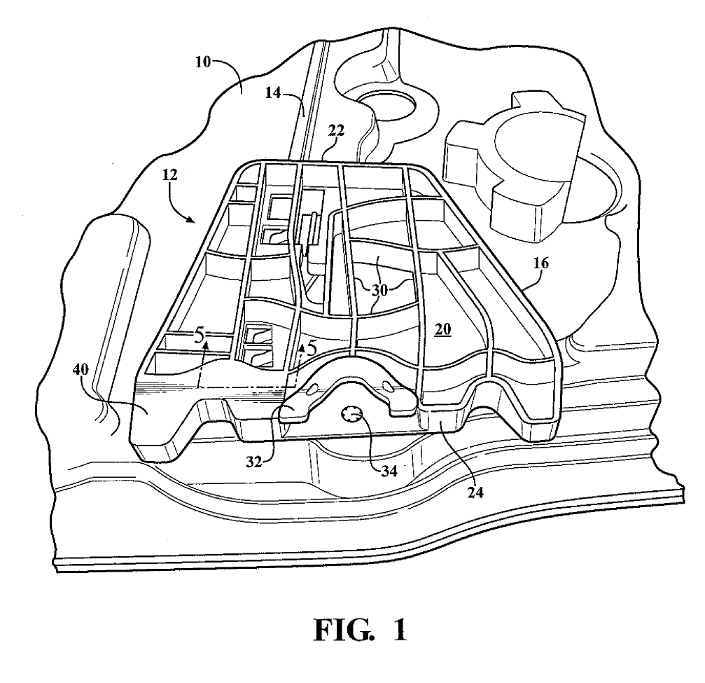

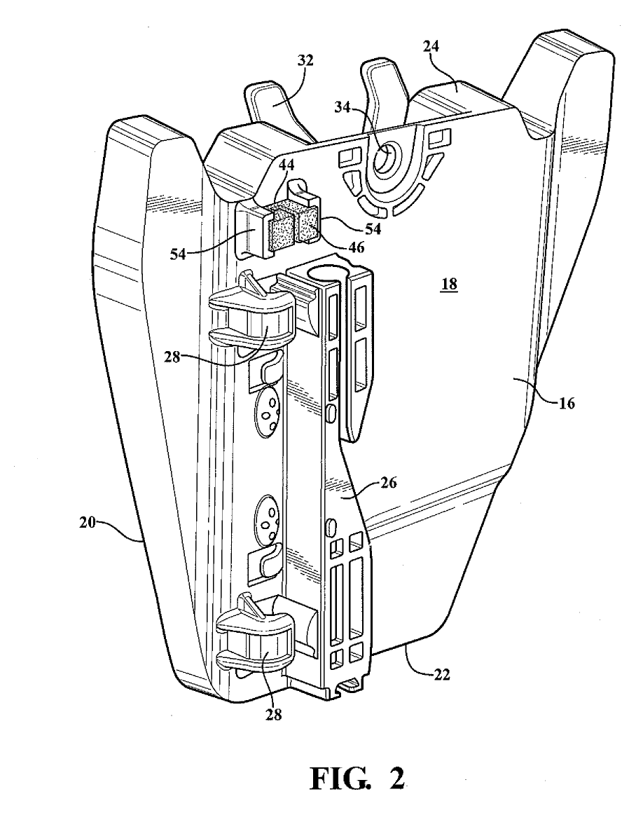

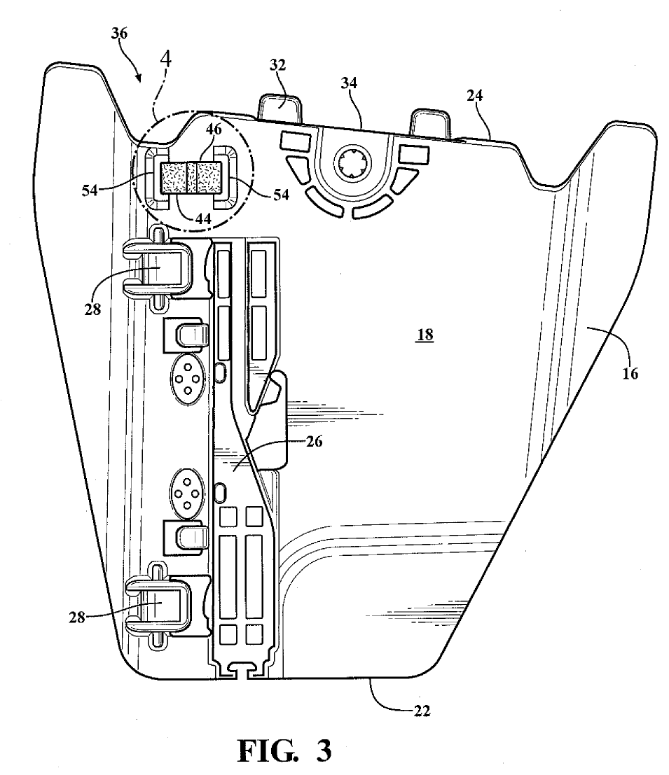

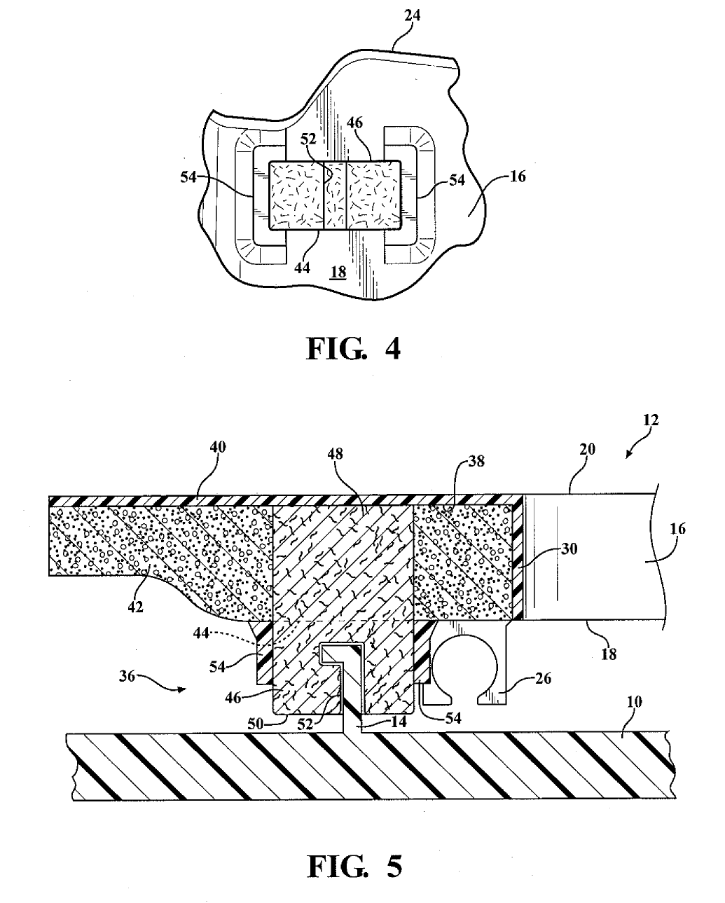

The lifter plate 16 also includes an integrated lubrication system, generally shown at 36 in FIG. 5. The lubrication system 36 lubricates the rail 14 and therefore the interface between the clips 28 and the rail 14 as the lifter plate 16 moves along the rail 14 in the vertical direction to provide smooth and easy movement of the window pane between the open and closed positions. The lubrication system 36 includes an enclosed reservoir 38 that is housed within the lifter plate 16 near the upper end 24 thereof. A back wall 40 of the reservoir 38 on the rear side 20 of the lifter plate 16 is shown in FIGS. 1 and 5. The reservoir 38 may be filled with a lubricant storing and releasing material 42, such as an oil impregnated, fibrous wicking material as is disclosed in commonly owned U.S. Pat. Nos. 3,466,244; 3,214,375; and 2,966,459, which are hereby incorporated by reference. An example of this material 42 is sold under the trademark PERMAWICK®, which is produced by Permawick Company of Birmingham, Mich. Alternatively, the reservoir 38 may be filled with a blend of formulated oil and thickening additives 42. An example of this material 42 is sold under the trademark PERMAGEL®, which is also produced by Permawick Company of Birmingham, Mich. Both of these materials 42 provide a predetermined oil release factor which controls or regulates the rate at which lubricant is released. The reservoir 38 is filled with one of the materials 42 through an aperture 44 in the front side 18 of the lifter plate 16 or through a re-sealable opening (not shown) in the back wall 40 of the reservoir 38. Rather than filling the reservoir 38 with one of the above-described materials, it is appreciated that any suitable lubricant may be used without varying from the scope of the invention.

The lubrication system 36 also includes a felt applicator 46 that automatically and continuously transfers lubricant from the reservoir 38 to the rail 14 as the lifter plate 16 moves along the rail 14 in the vertical direction. The applicator 46 extends through the aperture 44 in the front side 18 of the lifter plate 16 into the reservoir 38. The aperture 44 is positioned near the upper end 24 of the lifter plate 16 generally in-line with the clips 28. The applicator 46 is sized to fill-up the entire aperture 44. In other words, the peripheral edges of the applicator 46 directly contact the peripheral edges of the aperture 44. A first end 48 of the applicator 46 is in contact with an inner surface of the back wall 40 of the reservoir 38 to provide support to the applicator 46. A second end 50 of the applicator 46 protrudes from the front side 18 of the lifter plate 16. The second end 50 of the applicator 44 includes a slot 52 that is generally L-shaped and complementary to the L-shaped cross-section of the rail 14. The complementary shape of the slot 52 encompasses the rail 14 such that the applicator 46 contacts and lubricates every surface of the rail 14 as the lifter plate 16 moves along the rail 14 in the vertical direction. It is appreciated that the applicator 46 may be any suitable material without varying from the scope of the invention.

A pair of tabs 54 provides support to the second end 50 of the applicator 46 protruding from the front side 18 of the lifter plate 16 to maintain contact between the applicator 46 and the rail 14. The tabs 54 are spaced apart in a lateral direction and are disposed on opposite sides of the aperture 44. The space between the tabs 54 provides clearance for the rail 14. In the embodiment shown, viewed from the front side 18 of the lifter plate 16, the tabs 54 have opposing C-shapes such that each one of the tabs 54 engages the applicator 46 on three sides. The second end 50 of the applicator 46 extends farther from the front side 18 of the lifter plate 16 than the tabs 54. It is appreciated that the specific design of the tabs 54 may change depending upon the design of the applicator 46 and the cross-sectional shape of the rail 14 without varying from the scope of the invention.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed:

1. A window regulator assembly for moving a window pane between an open position and a closed position, said window regulator assembly comprising:
at least one elongated rail;
a lifter plate slidably coupled with said at least one elongated rail and adapted to be coupled with the window pane, whereby said at least one elongated rail guides said lifter plate to move the window pane between the open and closed positions;
a lubrication system lubricating said at least one elongated rail as said lifter plate moves the window pane between the open and closed positions, said lubrication system including a reservoir contained within said lifter plate, a lubricant storing and releasing material disposed in said reservoir, and an applicator extending from within said reservoir and lubricating said at least one elongated rail.

2. The window regulator assembly as set forth in claim 1 wherein said lifter plate includes an aperture providing access to said reservoir and said applicator extends through said aperture into said reservoir.

3. The window regulator assembly as set forth in claim 2 wherein said applicator entirely fills-up said aperture.

4. The window regulator assembly as set forth in claim 2 wherein said reservoir includes a back wall spaced apart from said aperture, said applicator extending between a first end disposed in said reservoir directly contacting said back wall and a second end protruding from said aperture and directly contacting said at least one elongated rail.

5. The window regulator assembly as set forth in claim 4 including a pair of tabs directly contacting and supporting said second end of said applicator maintaining contact between said second end of said applicator and said at least one elongated rail.

6. The window regulator assembly as set forth in claim 5 wherein each one of said pair of tabs extends from said lifter plate directly adjacent said aperture, said pair of tabs spaced apart on opposite sides of said aperture with said at least one elongated rail extending therebetween.

7. The window regulator assembly as set forth in claim 5 wherein said pair of tabs have opposing C-shapes such that each one of said pair of tabs engages said applicator on three sides.

8. The window regulator assembly as set forth in claim 5 wherein said second end of said applicator extends farther from said lifter plate than said pair of tabs.

9. The window regulator assembly as set forth in claim 4 wherein said second end of said applicator includes a slot complementary with said at least one elongated rail thereby lubricating each surface of said at least one elongated rail.

10. The window regulator assembly as set forth in claim 4 wherein said at least one elongated rail includes a generally L-shaped cross-section and said second end of said applicator includes a generally L-shaped slot complementary with said generally L-shaped cross-section of said at least one elongated rail thereby lubricating each surface of said at least one elongated rail.

11. The window regulator assembly as set forth in claim 1 wherein said lubrication system continuously lubricates said at least one elongated rail as said lifter plate moves the window pane between the open and closed positions.

12. A lifter plate for a window regulator assembly slidably coupled with a rail to move a window pane between an open position and a closed position, said lifter plate comprising:
a reservoir;
a lubricant storing and releasing material disposed in said reservoir; and
an applicator extending from within said reservoir and adapted for continuously lubricating the rail as said lifter plate moves the window pane between the open and closed positions.

13. The lifter plate as set forth in claim 12 including an aperture providing access to said reservoir and said applicator extends through said aperture into said reservoir.

14. The lifter plate as set forth in claim 13 wherein said applicator entirely fills-up said aperture.

15. The lifter plate as set forth in claim 13 wherein said reservoir includes a back wall spaced apart from said aperture, said applicator extending between a first end disposed in said reservoir directly contacting said back wall and a second end protruding from said aperture and adapted for directly contacting the rail.

16. The lifter plate as set forth in claim 15 including a pair of tabs directly contacting and supporting said second end of said applicator maintaining contact between said second end of said aperture and the rail, said pair of tabs extending from said lifter plate directly adjacent said aperture, and said pair of tabs spaced apart on opposite sides of said aperture with the rail extending therebetween.

17. The lifter plate as set forth in claim 16 wherein said pair of tabs have opposing C-shapes such that each one of said pair of tabs engages said applicator on three sides.

18. The lifter plate as set forth in claim 16 wherein said second end of said applicator extends farther from said lifter plate than said pair of tabs.

19. The lifter plate as set forth in claim 15 wherein said second end of said applicator includes a slot complementary with the rail such that said applicator is adapted for lubricating each surface of the rail.

20. The lifter plate as set forth in claim 12 wherein said lifter plate is adapted for continuously lubricating the rail as said lifter plate moves the window pane between the open and closed positions.
